(19) United States
(12) Patent Application Publication
(10) Pub. No.: US 2025/0005231 A1
(43) Pub. Date: Jan. 2, 2025

(54) Method and System for Inversion of Tire Material Parameters for Wheel Performance Simulation

(71) Applicant: CITIC Dicastal Co., Ltd., Qinhuangdao (CN)

(72) Inventors: Decai KONG, Qinhuangdao (CN); Yuling LANG, Qinhuangdao (CN); Shiwen XU, Qinhuangdao (CN); Zhihua ZHU, Qinhuangdao (CN); Shenglong YUAN, Qinhuangdao (CN); Wenbo WANG, Qinhuangdao (CN); Yiwu DU, Qinhuangdao (CN); Jingjing WANG, Qinhuangdao (CN); Weixin WANG, Qinhuangdao (CN); Shaobing HUANG, Qinhuangdao (CN)

(21) Appl. No.: 18/434,006

(22) Filed: Feb. 6, 2024

(30) Foreign Application Priority Data
Jun. 28, 2023 (CN) 202310768624.7

(51) Int. Cl. G06F 30/23; G06F 30/15; G06F 30/27; G06F 119/14

(52) U.S. Cl. CPC G06F 30/23; G06F 30/15; G06F 30/27; G06F 2119/14

(57) ABSTRACT

A method and system for inversion of tire material parameters for wheel performance simulation. Based on a plurality of sets of test data obtained through tire radial rigidity and lateral rigidity tests, a tire radial rigidity and lateral rigidity test finite element simulation model is established, and error calculation is performed by comparing simulation results; and then the tire material parameters are optimized by optimizing a platform and combining results of error analysis, and a simulation process is circulated until the error is minimal, which is fitting of a test curve and a simulation curve. By using a neural network model, rapid inversion of the tire material parameters may be realized by using the neural network model only through non-destructive tire rigidity test data. The tire material parameters may be modified according to a large deformation process of a tire in a 90-degree impact test of a wheel.

### TECHNICAL FIELD

The present disclosure relates to the technical field of automobile simulation, in particular to a method and system for inversion of material parameters for wheel performance simulation.

### BACKGROUND

With the rapid development of an automobile industry, automobiles have gradually become one of leading tools for riding instead of walk in today's society, but increasing energy consumption required by the automobile industry has brought serious environmental problems, and the contradiction between the automobiles and environmental protection is increasing. In order to alleviate these conflicts, also in order to actively respond to the national policy on environmental and energy problems, the automobile industry as a whole begins to pursue energy conservation, emission reduction and environmental protection. As an important means of vehicle energy conservation and emission reduction, vehicle lightweight has gradually become the key to enhance the market competitiveness of various automobile enterprises, and is also one of mainstream trends of vehicle development. As a core of a chassis, wheels are not only an only grounded part of a vehicle system, but also a rotating part of an unsprung mass of a vehicle system. Wheel lightweight can not only save energy and reduce emissions, but also improve maneuverability, ride comfort and other properties of the automobiles, which is of great significance. The benefit of reducing the mass of the wheels is several times that of reducing the sprung mass of the same size.

However, in the lightweight design of the wheels, it must be built on the basis of accurate evaluation of its mechanical properties. As a wheel structure is a key safety part, it is required to pass radial fatigue, bending fatigue, biaxial fatigue and other fatigue tests, and for a light alloy wheel, it is also necessary to pass 13-degree impact, 90-degree impact and other impact tests. Among them, the radial fatigue, biaxial fatigue, 13-degree impact and 90-degree impact tests are carried out for a wheel tire assembly, in which structure and mechanical properties of tires directly affect wheel performance during the above tests. Therefore, in order to accurately predict a stress state of the wheels in various bench tests, it is necessary to use accurate tire models.

Due to complexity of a tire structure and diversity of materials, it is difficult to construct an accurate tire model. One of important factors affecting the accuracy of the tire model is specific parameters of a tire material. As the tire material is a secret of a tire company, it is difficult to provide directly, the specific parameters of a material of each part in the tire are obtained through the tests, the tire needs to be destroyed, a material test sample is difficult to obtain, and the tests take a long time, which is not suitable for use. Therefore, many researchers choose to use an equivalent tire finite element model of the same rubber material or greatly simplify an internal structure of the tire when conducting finite element simulation of the performance of a wheel bench. For example, the tire is represented only by a 3D mesh unit of single-layer rubber, the structure and material inside the tire are ignored; or the tire is only divided into five parts of a tread, two side walls, a body and a lining layer for modeling, and other structures are ignored. These above simplification measures of the tire model will affect the accuracy of the tire model, and then affect the accuracy of wheel bench test simulation.

### SUMMARY

In order to avoid the problem that wheel bench performance simulation accuracy is reduced due to inaccurate tire material parameters, the present disclosure provides a method for inversion of tire material parameters for wheel bench performance simulation. A tire model established based on the tire material parameters obtained through inversion can not only meet the requirement of wheel anti-fatigue performance prediction when a tire has small deformation under the action of a fatigue load, but also meet the requirement of wheel anti-impact performance prediction when the tire has large deformation under the action of an impact load. For different types of tires, a neural network prediction model is provided to realize rapid prediction of the tire parameters and provide support for wheel research and development.

According to one aspect of the present disclosure, a method for inversion of tire material parameters for wheel performance simulation is provided and includes the following steps: a tire rigidity test step, wherein a displacement-load curve as a tire test curve is obtained through a tire rigidity test; a tire finite element modeling step, wherein a 2D tire section mesh is drawn and rotates around a central axis of a tire by 360° to form a tire finite element model of a 3D mesh; a tire rigidity test finite element modeling step, wherein load test simulation is carried out in a mode of reserving a contact surface in a test bench as a rigid surface and applying load and displacement to the contact surface, to establish a tire rigidity test finite element model; and a tire material parameter inversion step, wherein an inversion model of the tire material parameters is established, the selected tire material parameters are optimized, the tire rigidity test finite element model is simulated to obtain a displacement-load curve as a simulation curve, the tire material parameters are inversed by comparing the tire test curve and the simulation curve, and the tire rigidity test includes a tire radial rigidity test and a tire lateral rigidity test.

Optionally, the method for inversion further includes the following steps: a 90-degree impact test step, wherein a 90-degree impact test is performed on a wheel tire assembly, to obtain a tire deformation process in an impact process; a 90-degree impact test simulation step, wherein a tire model is established based on the tire material parameters obtained in the tire material parameter inversion step, and a simulation deformation process in a wheel 90-degree impact test process is obtained through simulation; and a tire material parameter modification step, wherein the tire deformation process is compared with the simulation deformation process, and the tire material parameters obtained in the tire material parameter inversion step are modified according to a comparison result.

Optionally, a computer executes a program to form a neutral network, the neural network is a BP neural network, and includes an input layer with 7 nodes, a hidden layer with 10 nodes and an output layer with 6 nodes, the 7 nodes of the input layer respectively represent input variables, namely, a tire inner diameter, a tire section width, a tire flattening rate, radial displacement-load curves of the tire under three different air pressures and a lateral displacement-load curve of the tire under 450 KPa, a transfer function from the input layer to the hidden layer is hyperbolic tangent function, and a transfer function from the hidden layer to the output layer is a nonlinear sigmoid transfer function.

According to another aspect of the present disclosure, a system for inversion of tire material parameters for wheel performance simulation is provided and configured to implement the above method for inversion of the tire material parameters.

According to the present disclosure, tire radial rigidity and lateral rigidity test finite element simulation models may be established based on a plurality of groups of test data obtained through the tire radial rigidity and lateral rigidity tests, and error calculation is carried out by comparing simulation results. Then, the tire material parameters are optimized by combining results of error analysis, and a simulation process is circulated until the test curve fits the simulation curve. Finally, the present disclosure relates to the field of neural networks, and a neural network model that can be configured to predict the tire material parameters is provided. The present disclosure realizes rapid inversion of the tire material parameters by using the neural network model only through tire rigidity test data.

Therefore, the present disclosure has the advantages that the tire material parameters that can represent the overall mechanical properties of the tire can be inversed by relying on results of a non-destructive and easily carried out tire rigidity test without complicated tire material testing, and the tire material parameters can be modified according to the large deformation process of the tire in the 90-degree impact test of the wheel. The obtained tire material parameters can not only meet the requirement of wheel fatigue test condition simulation with small tire deformation, but also meet the requirement of wheel impact condition simulation with large tire deformation, which is conducive to improving simulation accuracy of a wheel bench performance test, thus laying a foundation for wheel structural performance evaluation and structural lightweight design. In addition, a neural network prediction model of the tire material parameters established by the present disclosure can quickly predict the material parameters in the tire without finite element simulation iterative inversion for a new tire structure, and the material parameters may accurately characterize the overall mechanical properties of the tire, which is conducive to speeding up the process of wheel research and development.

### BRIEF DESCRIPTION OF FIGURES

FIG. 1 schematically shows a flow diagram of a method for inversion of tire material parameters according to the present disclosure;

FIG. 2 schematically shows a tire section profile and material distribution diagram;

FIG. 3 is a 2D finite element network diagram of a tire section;

FIG. 4 shows a 3D finite element model of a tire partitioned according to a material;

FIG. 5 is a 3D finite element model of a tire radial-lateral rigidity test;

FIG. 6 shows a condition of a fit degree between a test curve and a simulation curve for analyzing a displacement-load obtained through a tire radial rigidity test and lateral rigidity test;

FIG. 7 schematically shows a flow diagram of Isight cycle for inversion of tire material parameters; and

FIG. 8 is a schematic diagram of a BP neural network.

### DETAILED DESCRIPTION

Exemplary embodiments of the present disclosure are described in detail in conjunction with accompanying drawings. The exemplary embodiments described below and illustrated in the accompanying drawings are intended to teach the principles of the present disclosure and to enable those skilled in the art to implement and use the present disclosure in several different environments and for several different applications. Therefore, the scope of protection of the present disclosure is limited by the attached claims, and the exemplary embodiments are not intended to be, and should not be considered to be a restrictive description of the scope of protection of the present disclosure. Unless otherwise specified, the sequence and numerical values of components and steps described in the embodiments do not limit the scope of the present disclosure. Any numerical range stated herein is intended to include all subranges contained therein, and the numerical range represented by “numerical value A to numerical value B” refers to a range containing endpoint numerical values A and B. It may be understood by those skilled in the art that terms such as “first”, “second” and “step” in the present disclosure are used only to distinguish different steps, devices or modules, etc., and do not represent any specific technical meaning, nor do they represent an inevitable logical sequence between them, for example, certain two steps may be exchanged or carried out in parallel.

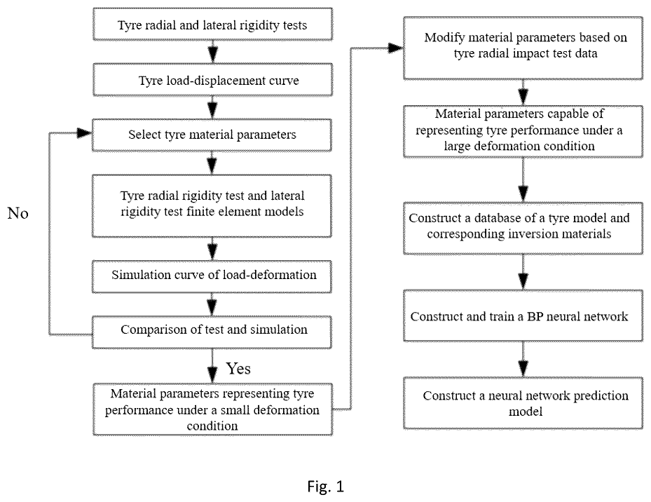

According to an implementation flow of a method for inversion of tire material parameters of the present disclosure, as shown in FIG. 1, the method specifically includes the following steps:

step 1, a tire rigidity test is carried out, to obtain a displacement-load curve as a tire test curve.

Specifically, according to a size of a common wheel of an automobile, different specifications of tires equipped with different sizes of wheels are selected, and at least 3-5 kinds of tire specifications that can be equipped with a certain size of wheels are selected. A radial rigidity test and a lateral rigidity test are carried out for the selected tires of different specifications (also called styles), and the displacement-load curve of the tires under conditions such as different tire pressures and different loads is obtained.

For example, according to tire rating data, each tire is designed for six working conditions including three radial working conditions and three lateral working conditions. The air pressures of the three lateral working conditions are 200 kPa, a standard air pressure and 450 kPa, and radial loads are 120%, 150% and 180% rated loads respectively. Air pressures of the three lateral working conditions are 450 kPa, and lateral loads are 60%, 100% and 120% rated loads respectively.

In a tire rigidity experiment, the load on the tire is small, so the deformation of the tire is relatively small, and therefore the obtained tire displacement-load curve can be regarded as a curve obtained in the small deformation stage of the tire. Since only a tire rigidity numerical value and a displacement-load curve diagram are obtained from the tire rigidity test, specific data of the curve is not provided. In order to obtain displacement-load data of the tire under different working conditions, it is necessary to preprocess the displacement-load curve diagram to extract the displacement-load curve data in the tire rigidity test.

Step 2, a tire finite element model is established.

Specifically, in order to properly simplify a tire structure, it may be divided into a plurality of main regions in CAD according to a main constituent material; a 2D tire section mesh is drawn, and a mesh unit type is adjusted to be able to support Abaqus operation; and the 2D tire section mesh rotates around a central axis of the tire by 360° to form a tire 3D mesh, that is the tire finite element model.

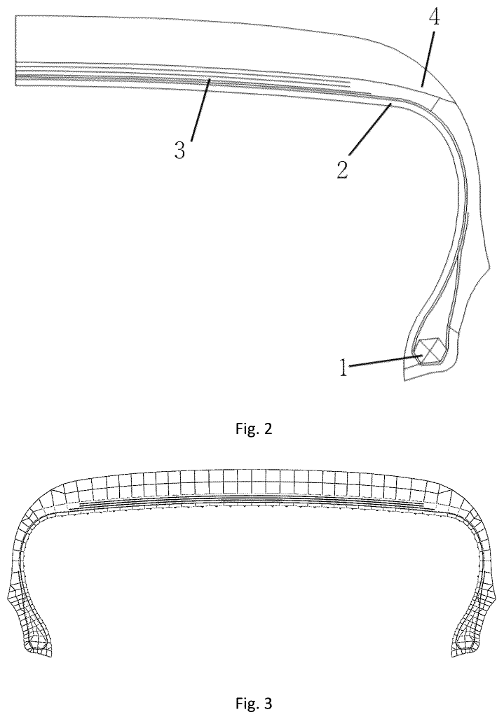

For example, according to an embodiment of the present disclosure, in order to facilitate tire simulation, the tire structure is reasonably simplified, the tire section profile diagram is divided into four main regions, namely a steel wire ring 1, a cord layer 2, a belt layer 3 and a rubber layer 4, according to the main constituent material in the CAD, specifically as shown in FIG. 2.

Secondly, the profile diagram may be introduced into Hypermesh to draw a mesh. In order to reduce operation time of later simulation, the mesh size may be adjusted appropriately, for example, the mesh may be divided according to 3-10 mm as a side length, or specifically as shown in FIG. 3, a side length of a mesh at a tire tread may be selected as 5-8 mm, and a side length of a mesh at a tire side wall may be selected as about 4 mm. A side length of a mesh at a bead toe may be selected as about 3 mm.

Then, the mesh is introduced into Abaqus, a constraint is established, a steel mesh is embedded into the cord layer 2 and the belt layer 3, and materials are assigned to the mesh in each region. In order to reduce later inversion variables, a Neo model is selected for the tire rubber material.

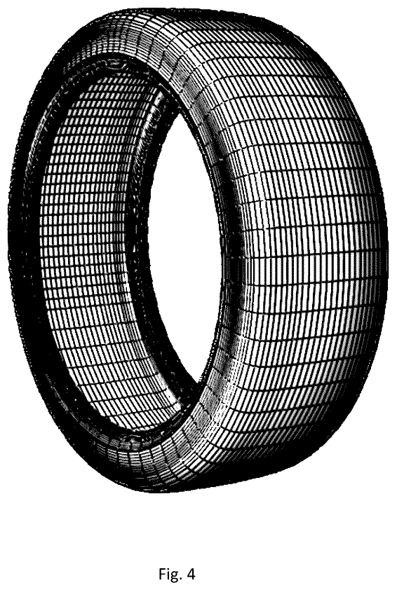

Finally, the 2D tire section mesh rotates around the central axis of the tire by 360° to form the tire 3D mesh, that is the tire finite element model, specifically as shown in FIG. 4. Step 3, tire radial rigidity test and lateral rigidity test finite element models are established, and simulated.

Specifically, the tire rigidity test finite element model may be established, abaqus software is adopted to carry out simulation to complete establishment of the tire radial rigidity test and lateral rigidity test finite element models, and an inp file is output.

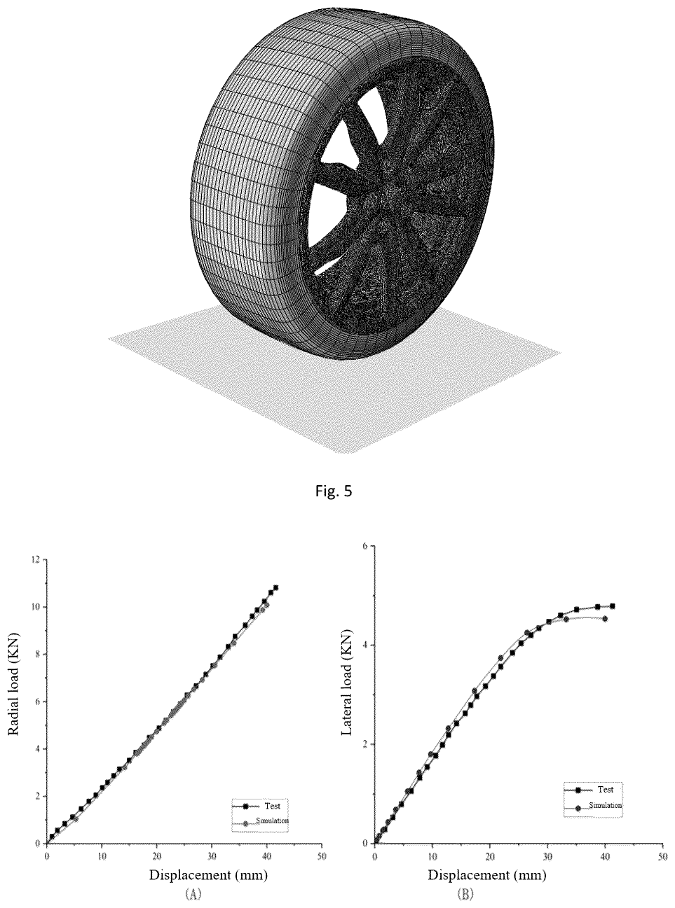

For example, according to an embodiment of the present disclosure, in order to reduce time of subsequent inversion of the tire material parameters, a wheel and a test bench are simplified to a certain extent when the tire rigidity test finite element model is established. Specifically as shown in FIG. 5, in the tire rigidity test finite element simulation, the wheel structure is simplified and the wheel is replaced with a rigid rim; the test bench is simplified, a contact surface in the test bench is reserved and set as a rigid surface, a fixed constraint is established in the center of the wheel, and remaining parts (e.g. a tire bracket) are simplified. Thus, in the tire rigidity test, the constraint of the test bench facing the tire is contact between a tread and a bench surface, and rigid contact is adopted. The simulation is carried out according to the test flow, radial load test simulation is carried out first, and load and displacement are applied to the contact surface according to radial rigidity test conditions. Then, on the basis of completing the test load, lateral load test simulation is carried out. According to the lateral rigidity test conditions, the load and displacement are applied to the contact surface, thus completing establishment of the tire radial rigidity test and lateral rigidity test finite element models, and the inp file is output.

Step 4, a tire material parameter inversion model is established.

Specifically, the tire material parameter inversion model may be established in an Isight integrated platform, and a multi-island genetic algorithm may be used to optimize the selected tire material parameters, tire rigidity test simulation is carried out, and a simulation result is compared with test data until a gap between the two is minimal. Thus, the material parameters reflecting tire performance may be obtained through inversion.

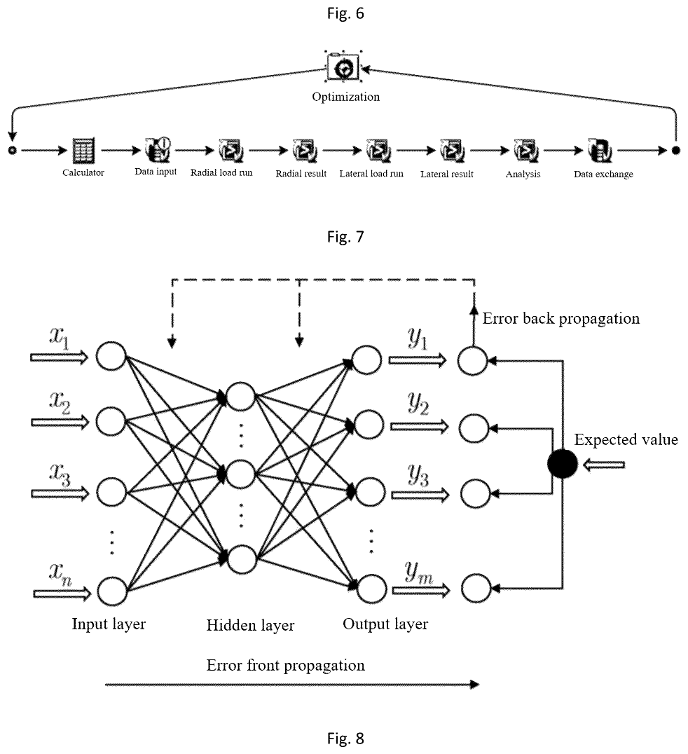

For example, according to an embodiment of the present disclosure, the tire material parameter inversion model is established in the Isight integrated platform, specifically as the Isight circulation process shown in FIG. 7. The tire material parameters are calculated by a Calculator module, and then the inp file is modified through a DATA input module, to achieve the purpose of modifying the tire rigidity test finite element model. Then, a tire radial rigidity test model is simulated in a radial load run (RA-LOAD-RUN) module, and simulation data of a tire radial displacement-load is extracted by a radial result (RA-RESULT) module. Simulation of a tire lateral rigidity test model is carried out in a lateral load run (LA-LOAD-RUN) module, and simulation data of a tire lateral displacement-load is extracted through a lateral result (LA-RESULT) module. An analysis (Analy) module judges the degree of fit between the displacement-load curve of the tire test and the displacement-load curve of simulation, as shown in FIG. 6, where FIG. 6 (A) shows a condition of the degree of fit between the test curve of the displacement-load obtained by analyzing the tire radial rigidity test and the simulation curve, and FIG. 6 (B) shows a condition of the degree of fit between the test curve of the displacement-load obtained by analyzing the tire lateral rigidity test and the simulation curve. According to the present disclosure, in order to more intuitively judge whether the two curves fit, a variance between the two curves is calculated as the basis for judging whether the two curves fit, and a variance between the corresponding test and simulation loads when the two curves of the test and the simulation are at the same displacement is compared. Then, the variance is returned to an optimization module through a data exchanger module as the basis for later parameter optimization.

More specifically, an optimization module with its own optimization algorithm may be used to optimize the selected tire material parameters by using the multi-island genetic algorithm here, and a selection range of the tire material parameters is shown in Table 1 below.

TABLE 1

| | Lower limit | Upper limit |
|---|---|---|
| Material name | of selection | of selection |
| Belt layer cord thread angle (°) | 10.0 | 27.0 |
| Belt layer cord thread cross sectional | 0.2 | 3.0 |
| area (mm²) | | |
| Rubber layer crown_C10(MPa) | 0.5 | 2.0 |
| Rubber layer side wall_C10(MPa) | 0.3 | 2.0 |
| Rubber tire body cord layer_C10(MPa) | 0.3 | 2.0 |
| Rubber layer bead filler_C10(MPa) | 0.6 | 2.0 |

In this way, the optimized tire material parameters may be input into the inp file of the tire radial rigidity test and lateral rigidity test by using the data exchanger module to achieve the purpose of modifying the tire rigidity test finite element model. Then, a Simcode module (not shown) is used to directly run the inp file of the tire radial rigidity test and lateral rigidity test. Finally, the Simcode module is used to calculate a variance of the test displacement-load curve and the simulation displacement-load curve of the tire, and the variance is returned to the optimization module through the data exchanger module as the basis for later parameter optimization.

Step 5, a 90-degree impact (namely radial impact) test is carried out on a wheel tire assembly, to obtain a tire deformation process in an impact process.

Specifically, according to the automobile industry standard, the wheel tire assembly may be installed on a 90-degree impact test bench to carry out an impact test, and a pull rope sensor is used to measure the tire deformation process during the impact process as a test result.

Step 6, the material parameters of the tire are modified based on a large deformation condition of the tire under the impact load.

The finite element simulation model of the 90-degree impact test of the wheel is established, firstly, the tire model is established based on the tire material parameters obtained in step 4, and the tire deformation process during the 90-degree impact test of the wheel is obtained through simulation. The tire deformation process obtained through simulation is compared with the test result, and the tire material parameters obtained in step 4 are modified according to the comparison result, so as to obtain the material parameters that can reflect the tire performance under the condition of large deformation.

Step 7, data are organized, to construct a tire material database.

Specifically, the tire database may be constructed based on the rigidity test data of each type of tire, and the tire material parameters obtained by inversion and modification, and the data set is divided into a training set and a test set.

For example, according to an embodiment of the present disclosure, the material parameters of various types of tires undergoing rigidity tests are inversed according to steps two to four. The displacement-load curve (considering the small number of data samples, it may include the displacement-load curve as the tire test curve and the displacement-load curve as the contact surface of the simulation curve at the same time) is processed, and matlab is used to write a numerical fitting program, which may automatically fit numerical points to a 13-order polynomial curve. Data of 12 points in each curve is selected to build a neural network database, and the data set is divided into the training set and the test set.

Step 8, a neural network is trained.

The type of the neural network selected by the present disclosure is a BP neural network, including an input layer with 7 nodes, a hidden layer with 10 nodes, and an output layer with 6 nodes (referring to Table 1), and its schematic structural diagram is shown in FIG. 8. The seven nodes of the input layer represent input variables respectively, namely, a tire inner diameter, a tire section width, a tire flattening rate, radial displacement-load curves of the tire under three different air pressures, and a lateral displacement-load curve of the tire under 450 KPa. A transfer function from the input layer to the hidden layer is a hyperbolic tangent function, and a transfer function from the hidden layer to the output layer is a nonlinear (sigmoid) transfer function.

The training set obtained in step 7, namely the tire model, the test condition, the displacement-load curve and inversion results, is used as training parameters of the BP neutral network to be input into the BP neural network for training, and a BP neural network model for inversion of the tire material parameters is obtained.

Step 9, the neural network is verified.

The test set obtained in step 7 is input into the BP neural network, and the tire model, the test condition and the displacement-load curve are taken as input parameters of the BP neural network. After the BP neural network runs, a network output value is obtained. If an error between an output value of the BP neural network and an input value of the corresponding tire material parameter is less than or equal to 0.5-1%, the verification of the neural network is completed.

In addition, a system for inversion of tire material parameters for wheel performance simulation provided by the present embodiment is configured to implement the above method for inversion and correspondingly includes the following modules: a tire rigidity test module, wherein a displacement-load curve as a tire test curve is obtained through a tire rigidity test; a tire finite element modeling module, wherein a 2D tire section mesh is drawn and rotates around a central axis of a tire by 360° to form a tire finite element model of a 3D mesh; a tire rigidity test finite element modeling module, wherein load test simulation is carried out in a mode of reserving a contact surface in a test bench as a rigid surface and applying load and displacement to the contact surface, to establish a tire rigidity test finite element model; and a tire material parameter inversion module, wherein an inversion model of the tire material parameters is established, the selected tire material parameters are optimized, the tire rigidity test finite element model is simulated to obtain a displacement-load curve as a simulation curve, and the tire material parameters are inversed by comparing the tire test curve and the simulation curve. A working process of the system is the same as a working process of the method for inversion of the tire material parameters for wheel performance simulation, which is not detailed here. Thus, inversion of the tire material parameters can be kept consistent with a real situation, the input accuracy of the simulation model and the inversion speed of the tire material parameters can be improved, the wheel performance can be predicted more accurately, and the method and system of the present disclosure may be implemented in many ways. For example, the method and system of the present disclosure may be implemented through software, hardware, firmware, or any combination of software, hardware, and firmware. The above sequence of steps for the method is for illustrative purposes only, and the steps for the method of the present disclosure are not limited to the sequence specifically described above, unless otherwise specifically stated. In addition, in some embodiments, the present disclosure may also be implemented as a program recorded in a recording medium, and the program includes machine-readable instructions for implementing the method according to the present disclosure. Thus, the present disclosure also covers the recording medium, such as a removable disk and a hard disk, for execution of the program according to the method of the present disclosure, the recording medium stores a computer program, and when the computer program is executed by a processor, the steps of the method executed in the embodiment of the method shown in FIG. 1 are executed. It should also be noted that components or steps in the system and method of the present disclosure may be disassembled and/or recombined. Such disassembly and/or recombination shall be regarded as an equivalent scheme of the present disclosure. The above description of the disclosed aspect is provided so that any person skilled in the art can make or use the present disclosure. Various modifications to these aspects are quite obvious to those skilled in the art, and the general principles defined herein may be applied to other aspects without departing from the scope of the present disclosure. Accordingly, the present disclosure is not intended to be limited to the aspects shown herein, but rather to the broadest extent consistent with the principles and novel features disclosed herein.

In the description of the present application, “several” means two or more unless otherwise expressly and specifically qualified. The embodiment of the present disclosure may be applied to electronic devices such as terminal devices, computer systems and servers, which may be operated in conjunction with numerous other general or special computing system environments or configurations. Well-known examples of terminal devices, computing systems, environments, and/or configurations suitable for use together with the electronic devices such as the terminal devices, the computer systems and the servers, include, but are not limited to: personal computer systems, server computer systems, thin clients, thick clients, handheld or laptop devices, microprocessor-based systems, set-top boxes, programmable consumer electronics, networked personal computers, minicomputer systems, large computer systems, and distributed cloud computing technology environments that include any of the above systems, etc. The electronic devices such as the terminal devices, the computer systems and the servers may be described in a general context of computer system executable instructions (such as program modules) executed by the computer system. In general, the program module can include routines, programs, object programs, components, logic, data structures, etc., that perform specific tasks or implement specific abstract data types. The computer systems/servers can be implemented in the distributed cloud computing environments where tasks are executed by a remote processing device linked through a communication network. In the distributed cloud computing environments, the program modules can reside on local or remote computing system storage media that include storage devices. Although the present disclosure has been described with reference to various concrete embodiments, it should be understood that transformation can be made within the spirit and scope of the idea of the present disclosure described. Therefore, it is intended that the present disclosure is not limited to the embodiments described, but will have the full scope defined by the language of the attached claims.

What is claimed is:

1. A method for inversion of tire material parameters for wheel performance simulation, comprising the following steps:
a tire rigidity test step, wherein a displacement-load curve as a tire test curve is obtained through a tire rigidity test;
a tire finite element modeling step, wherein a 2D tire section mesh is drawn and rotates around a central axis of a tire by 360° to form a tire finite element model of a 3D mesh;
a tire rigidity test finite element modeling step, wherein load test simulation is carried out in a mode of reserving a contact surface in a test bench as a rigid surface and applying load and displacement to the contact surface, to establish a tire rigidity test finite element model; and
a tire material parameter inversion step, wherein an inversion model of the tire material parameters is established, the selected tire material parameters are optimized, the tire rigidity test finite element model is simulated to obtain a displacement-load curve as a simulation curve, and the tire material parameters are inversed by comparing the tire test curve and the simulation curve, wherein
the tire rigidity test comprises a tire radial rigidity test and a tire lateral rigidity test, and the method for inversion of the tire material parameters further comprises the following steps:
a 90-degree impact test step, wherein a 90-degree impact test is performed on a wheel tire assembly, to obtain a tire deformation process in an impact process;
a 90-degree impact test simulation step, wherein a tire model is established based on the tire material parameters obtained in the tire material parameter inversion step, and a simulation deformation process in a wheel 90-degree impact test process is obtained through simulation; and
a tire material parameter modification step, wherein the tire deformation process is compared with the simulation deformation process, and the tire material parameters obtained in the tire material parameter inversion step are modified according to a comparison result.

2. The method for inversion of the tire material parameters according to claim 1, wherein in the tire rigidity test step, the radial rigidity test and the lateral rigidity test are carried out respectively for a plurality of specifications of selected tires that can be fitted with wheels, to obtain a displacement-load curve of the tires under different tire pressures and different load conditions, and the displacement-load curve is preprocessed to extract corresponding displacement-load curve data.

3. The method for inversion of the tire material parameters according to claim 1, wherein in the tire finite element modeling step, the 2D tire section mesh is drawn according to four regions divided by a steel wire ring, a cord layer, a belt layer and a rubber layer in a tire section profile diagram; and/or the mesh is divided according to 3-10 mm as a side length.

4. The method for inversion of the tire material parameters according to claim 1, wherein in the tire rigidity test finite element modeling step, a wheel is replaced with a rigid rim, a constraint of the test bench facing the tire is set as rigid contact between a tire tread and a test bench surface, and a fixed constraint is established in a center of the wheel, so as to establish a radial rigidity test finite element model and a lateral rigidity test finite element model of the tire.

5. The method for inversion of the tire material parameters according to claim 1, wherein in the tire material parameter inversion step, comparison of the tire test curve with the simulation curve is comparison of a variance between corresponding test and simulation loads under the same displacement.

6. The method for inversion of the tire material parameters according to claim 1, wherein a tire database is constructed based on tire rigidity test data of each type of tire, and the tire material parameters obtained through the tire material parameter inversion step and the tire material parameter modification step.

7. The method for inversion of the tire material parameters according to claim 6, wherein a computer executes a program to form a neutral network, the neural network is a BP neural network, which comprises an input layer with 7 nodes, a hidden layer with 10 nodes and an output layer with 6 nodes, the 7 nodes in the input layer respectively represent input variables, namely, a tire inner diameter, a tire section width, a tire flattening rate, radial displacement-load curves of the tire under three different air pressures and a lateral displacement-load curve of the tire under 450 KPa, a transfer function from the input layer to the hidden layer is a hyperbolic tangent function, and a transfer function from the hidden layer to the output layer is a nonlinear sigmoid transfer function.

8. The method for inversion of the tire material parameters according to claim 7, wherein based on the displacement-load curve as the tire test curve and/or the displacement-load curve as the simulation curve, a neural network database is constructed by fitting a polynomial curve and selecting data with a plurality of points from the curve, a data set is divided into a training set and a test set, a tire type, a test condition, a displacement-load curve and an inversion result in the training set are taken as training parameters of the BP neural network to be input into the BP neural network for training, to obtain a BP neural network model for inversion of the tire material parameters, the test set is input into the BP neural network, a tire model, a test condition and a displacement-load curve are taken as input parameters of the BP neural network, and when an error between an output value of the BP neural network and an input value of corresponding tire material parameters is less than or equal to 0.5-1%, verification of the neural network is completed.

9. A system for inversion of tire material parameters for wheel performance simulation, configured to implement the method for inversion of the tire material parameters according to claim 1, comprising the following modules:
a tire rigidity test module, wherein a displacement-load curve as a tire test curve is obtained through a tire rigidity test;
a tire finite element modeling module, wherein a 2D tire section mesh is drawn and rotates around a central axis of a tire by 360° to form a tire finite element model of a 3D mesh;
a tire rigidity test finite element modeling module, wherein load test simulation is carried out in a mode of reserving a contact surface in a test bench as a rigid surface and applying load and displacement to the contact surface, to establish a tire rigidity test finite element model; and
a tire material parameter inversion module, wherein an inversion model of the tire material parameters is established, the selected tire material parameters are optimized, the tire rigidity test finite element model is simulated to obtain a displacement-load curve as a simulation curve, and the tire material parameters are inversed by comparing the tire test curve and the simulation curve.
